(19) United States
(12) Patent Application Publication
(10) Pub. No.: US 2016/0093086 A1
(43) Pub. Date: Mar. 31, 2016

(54) Vehicle Display Device

(71) Applicant: YAZAKI CORPORATION, Tokyo (JP)

(72) Inventors: Ryo KOBAYASHI, Shizuoka (JP); Yoshinori ENDO, Shizuoka (JP); Yuichi YOSHIDA, Shizuoka (JP)

(21) Appl. No.: 14/865,743

(22) Filed: Sep. 25, 2015

(30) Foreign Application Priority Data
Sep. 26, 2014 (JP) 2014-196161
Sep. 26, 2014 (JP) 2014-196162

(51) Int. Cl. G06T 13/80; B60K 37/02

(52) U.S. Cl. CPC G06T 13/80; B60K 37/02; B60K 2350/2065

(57) ABSTRACT

A vehicle display device is configured to be mounted on a vehicle to provide information to a person on the vehicle by displaying images on a liquid crystal display. The vehicle display device includes a storage unit in which image data including a line drawing is stored, and a display control unit configured to display a plurality of mask images on the liquid crystal display such that the mask images are set with respect to the image data stored in the storage unit to mask a plurality of regions into which the line drawing in the image data is divided, and to execute a stepwise unmasking processing to remove the mask images sequentially along a drawing direction of the line drawing.

### CROSS-REFERENCE TO RELATED APPLICATIONS

The present application claims priority from Japanese Patent Application Nos. 2014-196161 and 2014-196162 both filed on Sep. 26, 2014, the entire contents of which are incorporated herein by reference.

### FIELD OF INVENTION

The present invention relates to a vehicle display device to be mounted on a vehicle to provide information to a person on the vehicle by means of a liquid crystal display.

### RELATED ART

Some vehicle display devices mounted on vehicles provide information to a person on a vehicle by means of a liquid crystal display (see, e.g., JP2012-006453A). A related art vehicle display device is configured to display animation on the liquid crystal display. For example, a video file may be stored in the vehicle display device so that the vehicle display device displays animation by playing the video file.

Video files typically have large data size. That is, the related art vehicle display device described above needs to have a video file of large data size stored therein to display animation. In addition, displaying animation based on a video file makes processing load heavy.

### SUMMARY

Illustrative aspects of the present invention provide a vehicle display device in which stored data size can be reduced and also processing load during an animation display can be reduced.

According to an illustrative aspect of the present invention, a vehicle display device is configured to be mounted on a vehicle to provide information to a person on the vehicle by displaying images on a liquid crystal display. The vehicle display device includes a storage unit in which image data including a line drawing is stored, and a display control unit configured to display a plurality of mask images on the liquid crystal display such that the mask images are set with respect to the image data stored in the storage unit to mask a plurality of regions into which the line drawing in the image data is divided, and to execute a stepwise unmasking processing to remove the mask images sequentially along a drawing direction of the line drawing.

According to another illustrative aspect of the present invention, the vehicle display device includes a storage unit in which divided image data including a line drawing divided into a plurality of regions is stored, and a display control unit configured to execute a stepwise display processing to display a plurality of images based on the divided image data stored in the storage unit on the liquid crystal display sequentially along a drawing direction of the line drawing.

According to the vehicle display devices described above, it is possible to provide various expressions with small data size.

Other aspects and advantages of the present invention will be apparent from the following description, the drawings and the claims.

### BRIEF DESCRIPTION OF THE DRAWINGS

FIG. 1 is a block diagram of a vehicle display device according to an exemplary embodiment of the invention;

FIG. 2 illustrates an example of display by the vehicle display device shown in FIG. 1;

FIG. 3A and FIG. 3B are diagrams illustrating (a part of) image data including a line drawing and stored in a memory and mask images set with respect to the image data, in which

FIG. 3A illustrates the order in which the mask images are removed, and FIG. 3B illustrates a drawing direction of the line drawing;

FIG. 4 is a diagram illustrating a processing for gradually reducing an area of an mask;

FIG. 5 is a flow chart of a method of display by the vehicle display device according to the exemplary embodiment;

FIG. 6A and FIG. 6B are diagrams illustrating (a part of) images based on divided image data, in which FIG. 6A illustrates the images based on the divided image data, and FIG. 6B illustrates a drawing direction of the line drawing; and

FIG. 7 illustrates a modified example of the vehicle display device, showing a state in which a stepwise unmasking processing in a first display region is being performed.

### DETAILED DESCRIPTION

Hereinafter, exemplary embodiments of the present invention will be described in detail with reference to the drawings. However, the following exemplary embodiments do not limit the scope of the claimed invention.

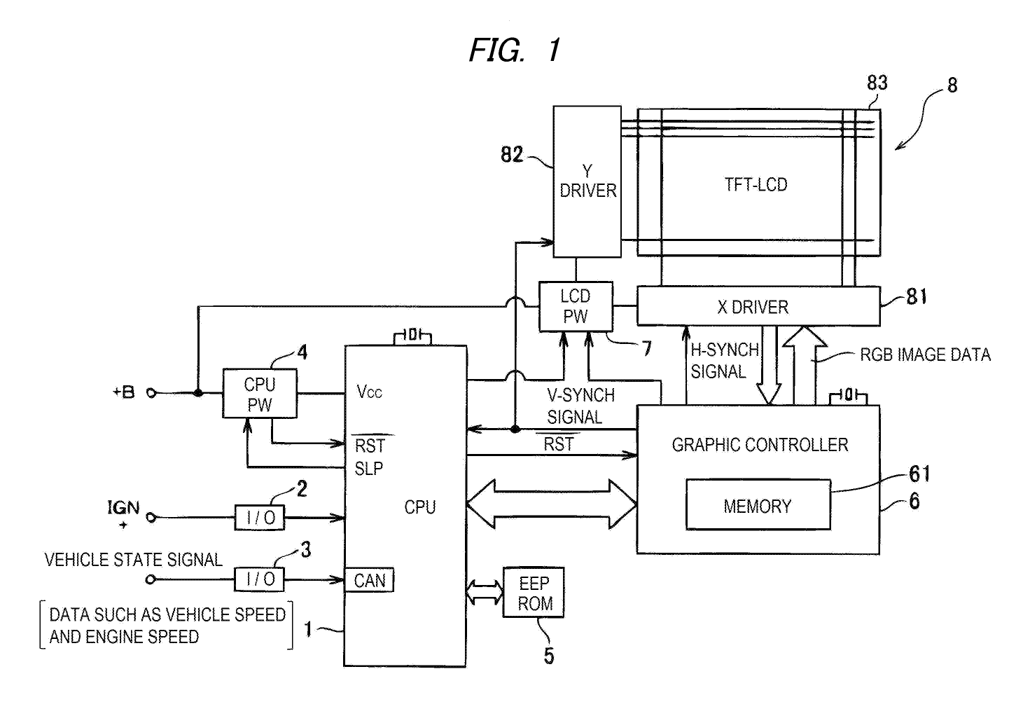

FIG. 1 is a block diagram of a vehicle display device according to an exemplary embodiment of the invention. The vehicle display device shown in FIG. 1 is a so-called graphic meter mounted on a vehicle having a thin film transistor liquid crystal display (TFT-LCD, an example of a liquid crystal display) as an indicator 8. The vehicle display device provides information to a person on the vehicle by displaying images on the indicator 8.

The indicator 8 is a display unit capable of displaying a color image. The indicator 8 displays an image of a meter such as a speed meter for indicating a traveling speed of the vehicle, a boost meter for indicating a value of supercharging pressure, a fuel meter for indicating an amount of remaining fuel, etc.

This vehicle display device has a central processing unit (CPU) 1 (an example of a display control unit), I/Os 2 and 3, a CPU power supply 4, an electrically erasable programmable read only memory (EEPROM) 5, a graphic controller 6 and a liquid crystal display (LCD) power supply 7 in addition to the indicator 8.

A signal (IGN+) indicating the state of an ignition switch on the vehicle side is inputted to the CPU 1 through the I/O 2, while the CPU 1 receives a vehicle state signal through the I/O 3 by means of a (controller area network (CAN) communication portion using a CAN as a communication protocol. The vehicle state signal includes information indicating a vehicle physical quantity to be displayed on the indicator 8, such as a vehicle speed or a supercharging pressure.

In addition, the CPU 1 transmits an instruction code to the graphic controller 6 in order to perform display based on the received vehicle state signal. The graphic controller 6 performs drawing processing in accordance with the instruction code.

DC power supplied from a positive-side power supply line (+B) on the vehicle side is inputted to the CPU power supply 4. The CPU power supply 4 generates a DV voltage (Vcc) required for the operation of the CPU 1. In addition, the CPU power supply 4 generates a reset signal in accordance with necessity or performs operation to suppress power supply in accordance with a sleep signal outputted from the CPU 1. The EEPROM 5 holds contents of programs to be executed by the CPU1, fixed data prepared in advance, etc.

The graphic controller 6 performs drawing processing in accordance with an instruction code from the CPU 1. The graphic controller 6 has a memory 61 (an example of a storage unit). The memory 61 stores data required for drawing. The memory 61 stores image data required for displaying a speed meter, a boost meter, a fuel meter, etc. The graphic controller 6 configured thus outputs R, G and B image data for drawing processing, and outputs a horizontal synchronizing signal and a vertical synchronizing signal to an X driver 81 and a Y driver 82 of the indicator 8 to control the X and Y drivers 81 and 82. Thus, an image of a speed meter, a boost meter, a fuel meter, etc. is displayed on a body portion 83 of the indicator 8.

DC power supplied from the positive-side power supply line (+B) on the vehicle side is inputted to the LCD power supply 7. The LCD power supply 7 generates predetermined DC power required for display of the indicator 8, and supplies the DC power to the indicator 8.

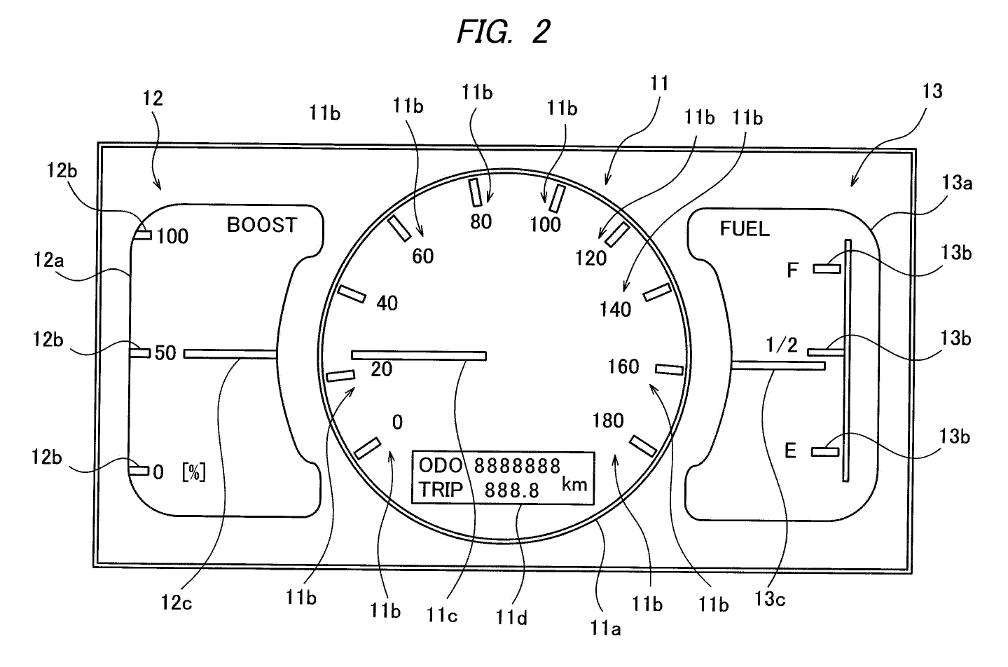

FIG. 2 illustrates an example of display by the vehicle display device shown in FIG. 1. The CPU1 uses instruction codes to send instructions to the graphic controller 6 as to where an image should be displayed or which image should be displayed. Thus, an image can be displayed on the indicator 8 as shown in FIG. 2.

Specifically the indicator 8 displays a speed meter in a first display region 11, displays a boost meter in a second display region 12 and displays a fuel meter in a third region 13.

An outer frame image 11 a serving as an outer frame of a circular speed meter, a scale image 11b indicating a speed value inside the outer frame image 11a, and a guiding image 11c rotating around the center position of the circular speed meter so as to point at the scale image 11b are displayed in the first display region 11. Further, an image 11d corresponding to an odo-trip meter is also displayed in the first display region 11.

An outer frame image 12a serving as a substantially concave shape placed sideways, a scale image 12b indicating a supercharging pressure value inside the outer frame image 12a, and a guiding image 12c extending in the lateral direction (X direction) of the indicator 8 and moving in the longitudinal direction (Y direction) of the indicator 8 so as to point at the scale image 12b are displayed in the second display region 12.

A fuel meter is displayed in the third display region 13 so that the fuel meter and the boost meter displayed in the second display region 12 can be arranged symmetrically across the speed meter displayed in the first display region 11. In detail, an outer frame image 13a serving as a substantially concave shape placed sideways with a concave portion facing in an opposite direction to that of the outer frame image 12a, a scale image 13b indicating an amount of remaining fuel inside the outer frame image 13a, and a guiding image 13c extending in the lateral direction (X direction) of the indicator 8 and moving in the longitudinal direction (Y direction) of the indicator 8 so as to point at the scale image 13b are displayed in the third display region 13.

Further, the CPU 1 transmits an instruction code to the graphic controller 6 to display characters such as “START UP” on an initial display screen displayed, for example, at a timing that the ignition switch is turned on. On this occasion, it is preferable that the characters “START UP” are displayed by animation in order to provide a sense of high class. However, it is inconvenient to store a video file having large data size to perform animation display. In addition, when performing animation display based on the video file, the load for processing the video file becomes heavy.

In this exemplary embodiment, therefore, the memory 61 of the graphic controller 6 stores image data of characters “START UP” (an example of a line drawing), and the CPU 1 makes the graphic controller 6 perform display based on the image data while performing animation display not using any video file but using a plurality of mask images.

More specifically, the CPU 1 performs a stepwise unmasking processing including the following steps (1) and (2). (1) Displaying a plurality of mask images on the indicator 8 such that the mask images are set with respect to the image data “START UP” stored in the memory 61 a to mask a plurality of regions into which a line drawing in the image data is divided, and after the step (1), (2) removing the mask images sequentially along a drawing direction of the line drawing.

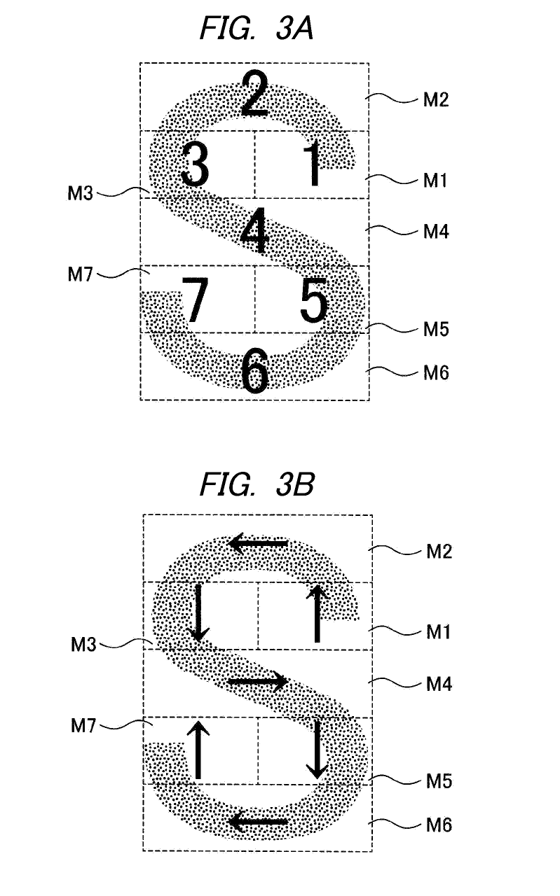

FIG. 3A and FIG. 3B are diagrams illustrating (a part of) image data including a line drawing and stored in the memory 61, and mask images set with respect to the image data. FIG. 3A illustrates the order in which the mask images are removed, and FIG. 3B illustrates a drawing direction of the line drawing. For example, image data of characters (line drawings) “START UP” is stored in the memory 61. As an example, only the character “S” will be described below.

First, the CPU 1 performs the step (1). That is, the CPU 1 displays a line drawing of “S” as an image on the indicator 8 based on the image data in the memory 61, divides the line drawing into a plurality of regions, and sets a plurality (seven in the illustrated example) of mask images M1 to M7 with respect to the image such that the mask images M1 to M7 mask the respective regions of the line drawing (see FIG. 3A). In this example, opacity of the mask images M1 to M7 in “1” and the color of the mask images M1 to M7 is the same as the background color. Therefore, when the mask images M1 to M7 are set, the line drawing of “S” cannot be recognized by a person on the vehicle looking at the indicator 8. Like in the present example, each of the mask images M1 to M7 may be rectangular or square.

The drawing direction of the line drawing as shown in FIG. 3B is set in advance. After the step (1), the CPU 1 removes the mask images M1 to M7 sequentially in the order shown in FIG. 3A, that is, in the order of numbers attached to the mask images M1 to M7 in FIG. 3A (the step (2)). The order of the numbers attached to the mask images M1 to M7 is set to correspond to the drawing direction of the line drawing (see FIG. 3B). By sequentially removing the mask images M1 to M7 in this manner, a person on the vehicle can visually recognize the line of “S” as if it is being drawn. Thus, animation display can be performed without using a video file.

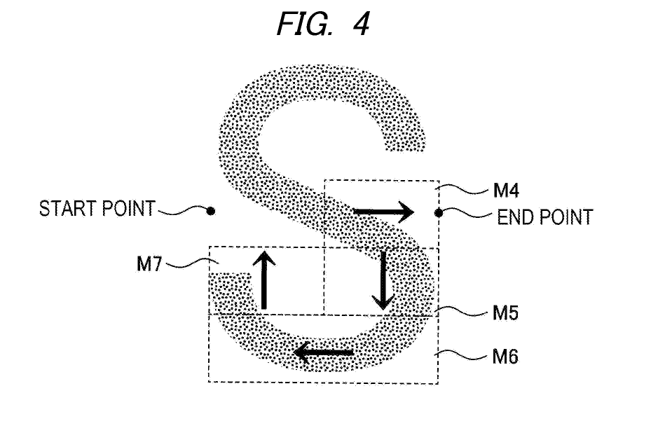

Further, the CPU 1 removes each mask image Ml to M7 so that the area of each mask image M1 to M7 is reduced gradually along the drawing direction of the line drawing. FIG. 4 is a diagram illustrating a processing for gradually reducing the area of the mask image M4.

When the first to third mask images M1 to M3 have been moved, the fourth mask image M4 is removed as shown in FIG. 4. The CPU 1 gradually reduces the area of the mask image M4 from the start point toward the end point in the drawing direction. Thus, the line can be visually recognized as if it is being drawn smoothly.

Specifically the CPU 1 sends, for example, the following instruction codes to the graphic controller 6 for the processing shown in FIG. 4. These instruction codes are for the area reducing processing with regard to the respective mask images.

<animate targetNode=“rect1” targetAttr=“height” dur=“200 ms” from“147” to=“0”/>

<animate targetNode=“rect2” targetAttr=“width” dur=“300 ms” begin=“200 ms” from“142” to=“0”/>

[animate targetNode=“rect1”] in the instruction code is an instruction to specify the first mask image M1, and [targetAttr=“height”] is an instruction to change the specified mask image in the height direction (Y direction). In addition, [dur=“200 ms” from“147” to=“0”] designates to reduce the height component of the first mask image M1 from 147 pixels to 0 pixels through 200 ms. Thus, the first mask image M1 changes to reduce its area gradually in the height direction.

In the same manner, [animate targetNode=“rect2”] in the instruction code is an instruction to specify the second mask image M2, and [targetAttr=“width”] is an instruction to change the specified mask image in the width direction (X direction). In addition, [dur=“300 ms” from“142” to=“0”] designates to reduce the width component of the second mask image M2 from 142 pixels to 0 pixels through 300 ms. Thus, the second mask image M2 changes to reduce its area gradually in the width direction.

Further, [begin=“200 ms”] in the instruction code designates a start time of control to reduce the area of the second mask image M2 gradually. That is, when the aforementioned step (2) is started in the exemplary embodiment, the area of the first mask image M1 is first reduced. This reduction step is carried out through 200 ms as described above. Therefore, the start time of control to reduce the area of the second mask image M2 is 200 ms later than the start time of execution of the aforementioned step (2). [begin=“200 ms”] designates that. Due to the instruction code including [begin=“200 ms”], the line drawing masked by the mask images M1 to M7 can be displayed sequentially and smoothly.

The area of each of the third to seventh mask images M3 to M7 is also reduced gradually by a similar instruction code. Further, [targetAttr=“height”] designates processing for changing an image from bottom to top. Therefore, in order to change an image such as the third mask image M3 or the seventh mask image M7 from top to bottom, an instruction to reduce a height component of the image in an opposite direction to that of the first mask image M1 is added to the instruction code as well as [targetAttr=“height”].

On the other hand, [targetAttr=“width”] designates processing for changing an image from right to left. Therefore, in order to change an image such as the fourth mask image M4 from left to right, an instruction to reduce a width component of the image in an opposite direction to that of the second mask image M2 is added to the instruction code as well as [targetAttr=“width”].

As described above, the CPU 1 performs a stepwise unmasking processing, that is, an instruction code transmission, in which the line drawing of “S” is displayed with the mask images M1 to M7 set thereon while the set mask images M1 to M7 are removed (preferably with the areas of the mask images M1 to M7 being reduced) sequentially along the drawing direction of “S”. Thus, the line drawing of “S” can be displayed by animation without using a video file. In addition, a similar stepwise unmasking processing is executed on the other characters “T”, “A”, “R”, “T”, “U” and “P” of “START UP”. Thus, all the characters “START UP” can be displayed by animation without using a video file. In this case, eighth and following mask images are set for “T”, “A”, “R”, “T”, “U” and “P”.

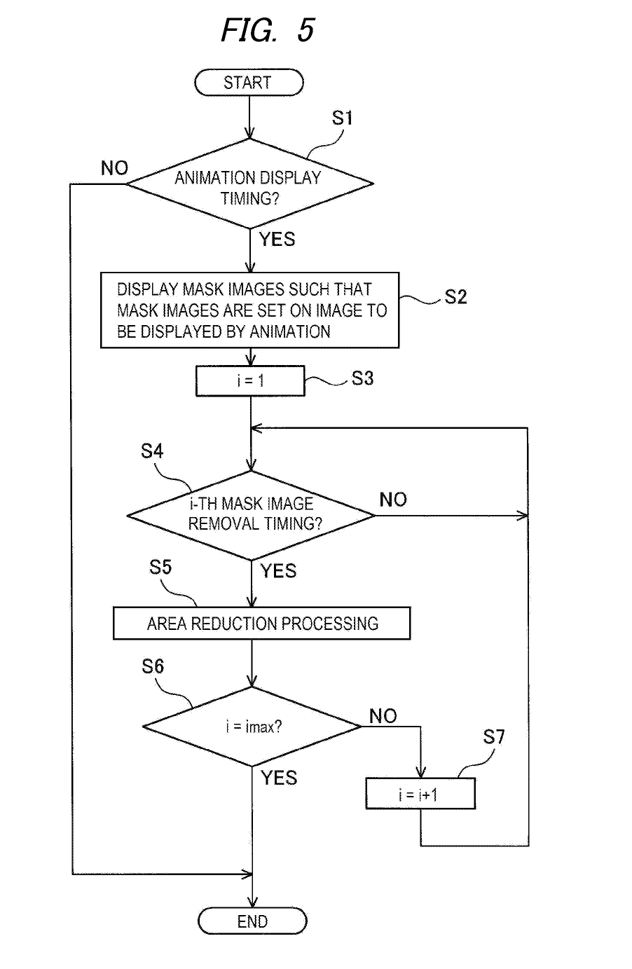

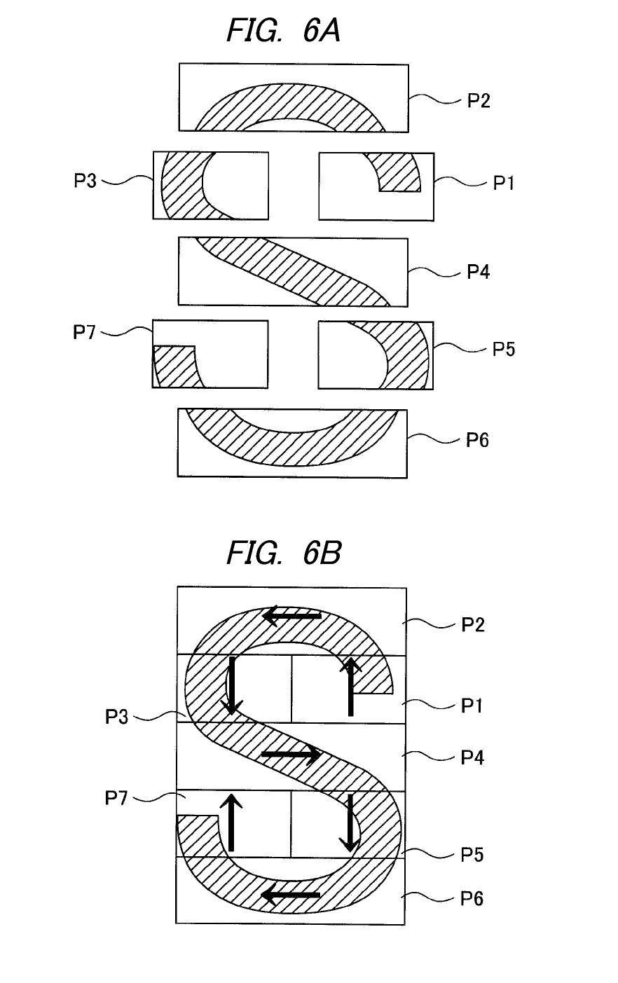

FIG. 5 is a flow chart of a method of display by the vehicle display device according to the exemplary embodiment. First, as shown in FIG. 6, the CPU 1 determines whether it is the timing of animation display, for example, whether it is immediately after the ignition switch is turned on (S1). When it is determined that it is not the timing of animation display (S1: NO), the processing shown in FIG. 6 is terminated.

When determining that it is the timing of animation display (S1: YES), the CPU 1 sets mask images on image data including a line drawing to be displayed by animation and displays the mask images (S2). That is, the CPU 1 transmits an instruction code to the graphic controller 6 to perform display based on the image data including the line drawing while transmitting an instruction code to the graphic controller 6 to divide the line image into a plurality of regions and set a plurality of mask images for masking the line image in the regions respectively.

The entire image data including the line drawing is masked by the mask images immediately after the step S2. Therefore, a person on the vehicle cannot recognize an image based on the image data.

Next, the CPU 1 initializes a variable i to “1” (S3). Next, the CPU 1 determines whether it is a timing to remove the i-th mask image Mi (S4). When it is determined that it is not the timing to remove (S4: NO), this processing is repeated until it is determined that it is the timing to remove.

When it is determined that it is the timing to remove (S4: YES), the CPU 1 executes a processing for reducing the area of the i-th mask image Mi (S5). In this processing, the CPU 1 sends an instruction code, like those described above, for the i-th mask image Mi to the graphic controller 6.

Then, the CPU 1 determines whether the variable i has reached the number imax of mask images set in the step S2 (S6). When it is determined that the variable i has not reached the number imax (S6: NO), the CPU 1 increments the variable i (S7) and moves to the step S4.

When it is determined that the variable i has reached the number imax (S6: YES), the processing shown in FIG. 6 is terminated. The steps shown in FIG. 6 are executed repeatedly until, for example, the ignition switch is turned off.

In this manner, according to the vehicle display device according to the exemplary embodiment, a line drawing in image data is divided into a plurality of regions, and a plurality of mask images for masking the line drawing are set in the regions respectively. The image data and the set mask images are displayed on the indicator 8 (an example of a liquid crystal display) while the mask images are removed sequentially along the drawing direction of the line drawing. Accordingly, a user who is visually viewing the indicator 8 can visually recognize a line as if it is being drawn as the mask images are removed sequentially. Thus, animation display can be performed. To perform display in this manner, image data including a line drawing are stored, and no video file is required. Accordingly, the stored data size can be reduced and also the processing load during animation display can be reduced.

In addition, the CPU 1 (an example of a display control unit) removes each of the mask images so that the area of the mask image is reduced gradually along the drawing direction of the line drawing. Accordingly, the user can visually recognize the line as if it is being drawn more smoothly. Thus, animation display can be performed without giving much odd feeling.

In addition, the CPU 1 sets the mask images that are square or rectangular. Accordingly, the processing load for setting the mask images can be also reduced, as compared with the case where mask images matching with the line drawing are set.

In addition, the CPU 1 performs the stepwise unmasking processing on an initial display screen displayed immediately after the ignition switch is turned on. Thus, the processing load during animation display on an opening screen at the time of starting the operation of the vehicle can be reduced with the stored data size being reduced.

According to another exemplary embodiment of the invention, the memory 61 of the graphic controller 6 stores divided image data in which characters “START UP” (an example of a line drawing) are divided into a plurality of regions, and the CPU 1 makes the graphic controller 6 perform display based on the divided image data. Thus, animation display can be performed without using a video file.

More specifically, the CPU 1 executes a stepwise display processing to display images based on the divided image data image data stored in the memory 61 sequentially along the drawing direction of a line drawing, the divided image data including image data of “START UP” divided into a plurality of regions.

FIG. 6A and FIG. 6B are diagrams illustrating an example of (a part of) images based on the divided image data. FIG. 6A illustrates the images based on the divided image data, and FIG. 6B illustrates the drawing direction of the line drawing. The divided image data in which each of the line drawings expressing the characters “START UP” is, for example, divided into a plurality of regions are stored in the memory 61. For example, for the line drawing of “S”, as shown in FIG. 6A, the memory 61 stores first to seventh divided image data in which the line drawing of “S” is divided into a plurality (seven) of regions. When displaying the first to seventh divided image data on the indicator 8, all of images P1 to P7 based on the first to seventh divided image data may be in a form of rectangular or square shape as illustrated. In addition, opacity of the rectangular or square images P1 to P7 may be “0” (i.e., transparent) in areas other than the line drawing.

Here, a drawing direction of the line drawing as shown in FIG. 6B is set in advance. The CPU 1 executes a stepwise display processing in which the images P1 to P7 based on the divided image data shown in FIG. 6A are displayed sequentially on the indicator 8 and along the drawing direction shown in FIG. 6B. That is, the CPU 1 displays the image P1, the image P2 and the image P3 on the indicator 8 sequentially in that order, and displays the image P7 at the end. In this manner, a person on the vehicle can visually recognize, for example, the line of “S” as if it is being drawn. Thus, animation display can be performed without using a video file.

Further, the CPU 1 displays each of the images P1 to P7 based on the plurality of pieces of divided image data so that the area of the image P1 to P7 can be expanded gradually along the drawing direction of the line drawing.

Specifically the CPU 1 sends, for example, the following instruction codes to the graphic controller 6 to perform this processing. The instruction codes are for the processing of expanding areas of images based on divided image data.

<animate targetNode=“pic1” targetAttr=“height” dur=“200 ms” from“0” to=“147”/>

<animate targetNode=“pic2” targetAttr=“width” dur=“300 ms” begin=“200 ms” from“0” to=“142”/>

[animate targetNode=“pic1”] in the instruction code is an instruction to specify the image P1 based on the first divided image data, and [targetAttr=“height”] is an instruction to change the specified image in the height direction (Y direction). In addition, [dur=“200 ms” from“0” to=“147”] designates to expand the height component of the image P1 based on the first divided image data from 0 pixels to 147 pixels through 200 ms. Thus, the image P1 based on the first divided image data is displayed to expand its area gradually in the height direction.

In the same manner, [animate targetNode=“pic2”] in the instruction code is an instruction to specify the image P2 based on the second divided image data, and [targetAttr=“width”] is an instruction to change the specified image in the width direction (X direction). In addition, [dur=“300 ms” from“0” to=“142”] designates to expand the width component of the image P2 based on the second divided image data from 0 pixels to 142 pixels through 300 ms. Thus, the image P2 based on the second divided image data is displayed to expand its area gradually in the width direction.

Further, [begin=“200 ms”] in the instruction code designates a start time of control to expand the area of the image P2 based on the second divided image data gradually. That is, when execution of the aforementioned stepwise display processing is started in the exemplary embodiment, the area of the image P1 based on the first divided image data is first expanded. This expansion step is carried out through 200 ms as described above. Therefore, the start time of control to expand the area of the image P2 based on the second divided image data is 200 ms later than the start time of the execution of the aforementioned stepwise display processing. [begin=“200 ms”] designates that. Due to the instruction code including [begin=“200 ms”], the images P1 to P7 based on the divided image data can be displayed sequentially and smoothly.

The area of each of the images P3 to P7 based on the third to seventh divided image data is also expanded gradually by a similar instruction code. Further, [targetAttr=“height”] designates processing for changing an image from bottom to top. Therefore, in order to change an image such as the image P3 based on the third divided image data or the image P7 based on the seventh divided image data from top to bottom, an instruction to expand a height component of the image in an opposite direction to that of the image P1 based on the first divided image data is added to the instruction code as well as [targetAttr=“height”].

On the other hand, [targetAttr=“width”] designates processing for changing an image from right to left. Therefore, in order to change an image such as the image P4 based on the fourth divided image data from left to right, an instruction to expand a width component of the image in an opposite direction to that of the image P2 based on the second divided image data is added to the instruction code as well as [targetAttr=“width”].

As described above, for the line drawing of “S”, the CPU 1 performs a stepwise display processing, that is, an instruction code transmission process, in which the images P1 to P7 based on a plurality of pieces of divided image data are displayed (and preferably the areas of the images P1 to P7 are expanded) sequentially along the drawing direction of “S”. Thus, the line drawing of “S” can be displayed by animation without using any video file. In addition, a similar stepwise display processing is executed on the other characters “T”, “A”, “R”, “T”, “U” and “P” of “START UP”. Thus, all the characters “START UP” can be displayed by animation without using any video file. In this case, not to say, images based on eighth and following divided image data are displayed for “T”, “A”, “R”, “T”, “U” and “P”.

In this manner, according to the vehicle display device according to the exemplary embodiment, images based on a plurality of pieces of divided image data that have been stored are displayed on the indicator 8 sequentially along the drawing direction of a line drawing. Accordingly, a user who is looking at the indicator 8 can visually recognize a line as if it is being drawn as the images based on the plurality of pieces of divided image data are displayed sequentially. Thus, animation display can be performed. To perform display in this manner, it is sufficient if divided image data in which a line drawing is divided into a plurality of regions is stored, and no video file is required. Accordingly, the stored data size can be reduced and also the processing load during the animation display can be reduced.

Particularly, in the exemplary embodiment, in the plurality of pieces of divided image data, the opacity of any other part than the line drawing is “0”. Therefore, even when the background includes a large number of colors or has gradations in spite of a single color, animation display can be performed without giving any influence to those many colors or the gradations.

In addition, the CPU 1 (an example of a display control unit) displays each of the images based on the plurality of pieces of divided image data so that the area of the image can be expanded gradually along the drawing direction of the line drawing. Accordingly, the user can visually recognize the line as if it is being drawn more smoothly. Thus, animation display can be performed without giving much odd feeling.

In addition, the memory 61 stores the divided image data in which the line drawing is divided into a plurality of square or rectangular regions. Accordingly, processing during the stepwise display processing for the square or rectangular image data can be prevented from being complicated, as compared with the case where divided image data include only the shape of a line drawing. It is therefore possible to reduce the processing load.

In addition, the CPU 1 performs the stepwise display processing on an initial display screen displayed immediately after the ignition switch is turned on. Thus, the processing load during animation display on an opening screen at the time of staring the operation of the vehicle can be reduced with the stored data size being reduced.

While the present invention has been described with reference to certain exemplary embodiments thereof, the scope of the present invention is not limited to the exemplary embodiments described above, and it will be understood by those skilled in the art that various changes and modifications may be made therein without departing from the scope of the present invention as defined by the appended claims.

For example, in the vehicle display device according to the exemplary embodiment, it is determined whether it is the timing of animation display, for example, immediately after the ignition switch is turned on. However, the timing of animation display is not limited to the timing immediately after the ignition switch is turned on, but may be, for example, immediately after an engine starts.

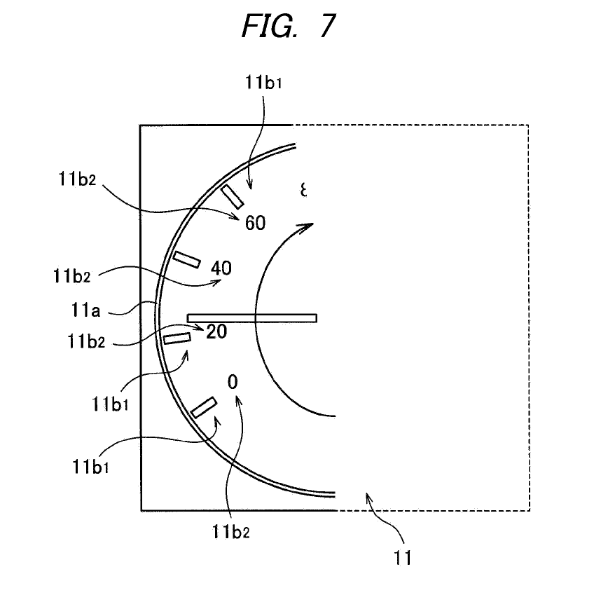

Further, in the vehicle display device according to each of the aforementioned exemplary embodiments, the stepwise unmasking processing or the stepwise display processing is executed for characters such as “START UP”. However, the invention is not limited thereto. FIG. 7 illustrates a modified example of the vehicle display device, showing a state in which the stepwise unmasking processing in the first display region 11 is being performed.

When the stepwise unmasking processing or the stepwise display processing according to the aforementioned exemplary embodiment is executed as shown in FIG. 7, animation display can be performed not only for characters such as “START UP” but also for another figure or the like. For example, the drawing direction of the circular outer frame image 11a may be set as a clockwise direction (the direction of the arrow in FIG. 7) so that animation display is performed to draw the outer frame image 11a. Further, a scale body image 11b1 of the scale image 11b may be displayed clockwise by animation in sync with the animation display of the outer frame image 11a. In addition, a numerical value image 11b2 indicating a speed value may be displayed adjacently to the scale body image 11b1 by animation in the same manner as the character of “S”.

In addition, this is not limited to the first display region 11, but may be applied to display in the second and/or third display region 12, 13.

Further, the vehicle display device according to the exemplary embodiments described above is not limited to display of a vehicle meter, but the exemplary embodiment may be applied to image display of a navigator or the like.

What is claimed is:

1. A vehicle display device configured to be mounted on a vehicle to provide information to a person on the vehicle by displaying images on a liquid crystal display, the vehicle display device comprising:
a storage unit in which image data including a line drawing is stored; and
a display control unit configured to display a plurality of mask images on the liquid crystal display such that the mask images are set with respect to the image data stored in the storage unit to mask a plurality of regions into which the line drawing in the image data is divided, and to execute a stepwise unmasking processing to remove the mask images sequentially along a drawing direction of the line drawing.

2. The vehicle display device according to claim 1, wherein the display control unit removes each of the mask images such that an area of the mask image is reduced gradually along the drawing direction of the line drawing.

3. The vehicle display device according to claim 1, wherein the display control unit is configured to set the mask images each having a square or rectangular shape.

4. The vehicle display device according to claim 1, wherein the display control unit is configured to execute the stepwise unmasking processing on an initial display screen that is displayed immediately after an ignition switch of the vehicle is turned on.

5. A vehicle display device configured to be mounted on a vehicle to provide information to a person on the vehicle by displaying images on a liquid crystal display, the vehicle display device comprising:
a storage unit in which divided image data including a line drawing divided into a plurality of regions is stored; and
a display control unit configured to execute a stepwise display processing to display a plurality of images based on the divided image data stored in the storage unit on the liquid crystal display sequentially along a drawing direction of the line drawing.

6. The vehicle display device according to claim 5, wherein the display control unit is configured to display each of the images based on the divided image data such that an area of the image is expanded gradually along the drawing direction of the line drawing.

7. The vehicle display device according to claim 5, wherein each of the regions into which the line drawing is divided in the divided image data stored in the storage unit has a square or rectangular shape.

8. The vehicle display device according to claim 5, wherein the stepwise display processing is performed on an initial display screen that is displayed immediately after an ignition switch of the vehicle is turned on.
